(19) United States
(12) Patent Application Publication
(10) Pub. No.: US 2011/0099031 A1
(43) Pub. Date: Apr. 28, 2011

(54) REAL TIME CAPTURE AND COMMUNICATION OF IN-TRANSIT PATIENT MEDICAL INFORMATION

(76) Inventor: DEEPTHI S. NAIR, Santa Clara, CA (US)

(21) Appl. No.: 12/607,076

(22) Filed: Oct. 28, 2009

(51) Int. Cl. G06Q 50/00; G06F 15/16; G06F 17/40; G10L 15/26; G06F 17/30; G01C 21/00

(52) U.S. Cl. 705/3; 709/204; 704/235; 701/207; 704/E15.043

(57) ABSTRACT

Several methods and a system for real time capture and communication of in-transit patient medical information are disclosed. In one embodiment, the system includes an instrument to capture a health data of a patient while the patient is in transit from a first location to a second location. The system also includes, an integration device having a processor and a memory coupled to the instrument and other instruments capturing the health data of the patient while the patient is in transit from the first location to the second location. In addition, the system includes a communication module of the integration device to transmit the health data to one or more of a client device, a dispatcher device, a hospital based device, a law enforcement device and an emergency personnel device while the patient is in transit from the first location to the second location.

### FIELD OF TECHNOLOGY

This disclosure relates generally to a field of medical technology and associated action for the treatment and more particularly to a real time capture and communication of in-transit patient medical information.

### BACKGROUND

The emergency personnel while transporting a patient from the incident site to a hospital provide critical medical care. The critical medical care includes assessing the status of the patient and if necessary provide breathing support, monitor blood pressure and prescribe some medication. Once medical status check of the patients status is done, the patient stabilized then the emergency personnel conveys the patient medical status verbally to the medical care provider e.g. hospital nurse or doctor.

The emergency personnel also provide the written medical chart to the nurse or doctor upon arrival to the hospital emergency services. The emergency personnel also conveys verbally via radio about the patient's medical status. The medical records of the patient in the hospital and the emergency personnel update are not synchronized instantly and valuable data may be lost. The communication between the emergency personnel and the medical personnel may not be recorded and human error might lead to wrong diagnosis and may be detrimental to the patient's health.

### SUMMARY

Several methods and a system for real time capture and communication of in-transit patient medical information are disclosed. In one embodiment, the system includes an instrument to capture a health data of a patient while the patient is in transit from a first location to a second location. The system also includes, an integration device having a processor and a memory coupled to the instrument and other instruments capturing the health data of the patient while the patient is in transit from the first location to the second location. In addition, the system includes a communication module of the integration device to transmit the health data to one or more of a client device, a dispatcher device, a hospital based device, a law enforcement device and an emergency personnel device while the patient is in transit from the first location to the second location.

The instrument may be a medical device, a medical diagnostic device, a medical care device, a recording device of the emergency personnel and/or a mobile device. The system may also include an input module, an update module, and a wireless module. The input module may process an instruction data from one of an emergency personnel, a doctor, a patient, a dispatcher, a hospital staff, and/or a law enforcement personnel. The update module may periodically process and store the health data, the instruction data and/or the group communication data with a central server. The wireless module may download a medical protocol by the emergency personnel.

An analysis module of the integration device may collect a group communication data from the client device, the dispatcher device, the hospital based device, the law enforcement device and/or the emergency personnel device. A medical data module of the integration device may capture a medical data of the patient.

The system may further include a reader module and a storage module. The reader module may electronically read a personal data by one or more of the emergency personnel, the doctor, the patient, the dispatcher, the hospital staff, and/or the law enforcement personnel. The storage module may capture the health data, the instruction data, a communication data, the medical protocol, the medical data and/or the personal data. The personal data may be a name, an address, a personal identification number, a license and/or a medical number.

An advanced interface module of the communication module may transmit the instrument information to one or more of the emergency personnel, the doctor, the patient, the dispatcher, the hospital staff, and/or the law enforcement personnel. The advanced interface module may be a universal serial bus (USB) interface, a Bluetooth interface, a Zigbee interface, a WiFi interface, a WiMax, a PoE, a Wibree, a RS-232, a RS-422, a RS-485, VHF radio, satcom, cellular and/or an Ethernet interface.

In another embodiment, a method includes processing an initial medical report by an emergency personnel while a patient is in transit from a first location to a second location. The method also includes automatically capturing a health data of the patient by two or more devices. The devices include a medical device, a medical diagnostic device, a medical care device, a recording device of the emergency personnel and a mobile device while the patient is in transit from the first location to the second location. An event summary is periodically updated to communicate to the emergency personnel while the patient is in transit from the first location to the second location. The health data is recorded from an identification card of the patient while the patient is in transit from the first location to the second location. Further, the health data from the identification card is matched with a medical record of the patient while the patient is in transit from the first location to the second location.

The medical diagnostic device may be a blood glucose monitor, a troponin monitor and/or a blood testing machine. The medical care device may be a pulse monitor, an electrocardiogram machine, vital signs monitor, IV pump, oxygen concentrator, an x-ray machine and/or a sonogram machine.

The health data of the patient may be simultaneously transmitted to one or more of a medical personnel, a hospital staff, a law enforcement personnel and/or the emergency personnel. The voice command may be transcribed to a text format to store as the medical record of the patient. Further, a geospatial location of an emergency vehicle may be transmitted to alert the medical personnel, the hospital staff, a law enforcement personnel and/or an emergency personnel. A medical protocol may be downloaded to assist the emergency personnel to treat the patient and an instruction may be received by the emergency personnel to treat the patient. The emergency personnel may be enabled to record verbal communication to the device.

In yet another embodiment, the method includes automatically capturing a health data of the patient by the devices. The devices include a medical device, a medical diagnostic device, a medical care device, a recording device of the emergency personnel and a mobile device while the patient is in transit from the first location to the second location. The method also includes recording the health data from an identification card of the patient while the patient is in transit from the first location to the second location. The health data from the identification card is matched with a medical record of the patient while the patient is in transit from the first location to the second location.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a systematic view illustrating communication between a dispatcher, a location tracking system, a hospital and emergency vehicles through a network, according to one embodiment.

FIG. 2 is a schematic view illustrating transit of a patient in an emergency vehicle, according to one embodiment.

FIG. 3 illustrates a diagrammatic view illustrating a patient intensive care system in an emergency vehicle, according to one embodiment.

FIG. 4 is a diagrammatic view illustrating an emergency personnel transferring a patient's vital health information to a hospital person, according to one embodiment.

FIG. 5 is a system view illustrating communication between an integration device, a server device and a hospital attendant, according to one embodiment.

FIG. 6 is an exploded view of an integration device illustrated in FIG. 5, according to one embodiment.

FIG. 7 is a flow chart illustrating dispatching of an emergency vehicle and transmitting a patient health information from the emergency vehicle to a hospital, a law enforcement personnel and an administrator, according to one embodiment.

FIG. 8 is a flow chart illustrating a medical protocol for a ventricular fibrillation/ventricular tachycardia, according to one embodiment.

FIG. 9A is a process flow that illustrates an automated capturing of a patient health information and transmitting to a hospital based device, and/or a law enforcement personnel, according to one embodiment.

FIG. 9B is a continuation of the process flow illustrated in FIG. 9A illustrating additional operations, according to one embodiment.

Other features of the present embodiments will be apparent from the accompanying drawings and from the detailed description that follows.

### DETAILED DESCRIPTION

Several methods and a system for real time capture and communication of in-transit patient medical information are disclosed. Although the present embodiments have been described with reference to specific example embodiments, it will be evident that various modifications and changes may be made to these embodiments without departing from the broader spirit and scope of the various embodiments.

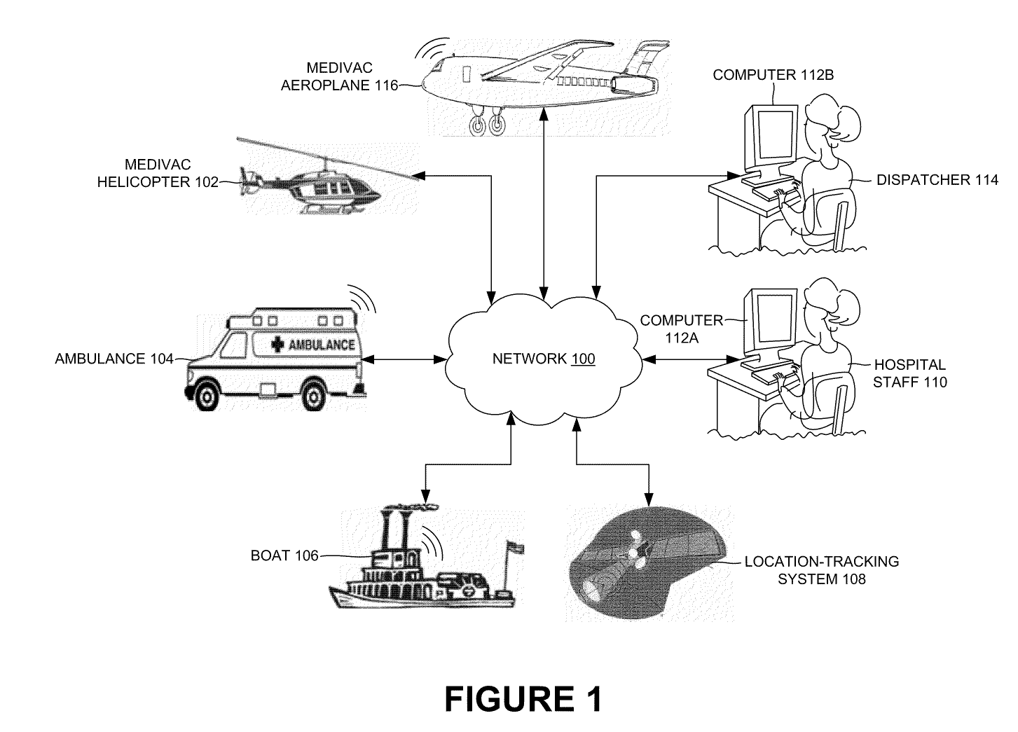

FIG. 1 is a systematic view illustrating communication between a dispatcher, a location tracking system, a hospital and emergency vehicles through a network, according to one embodiment.

According to one embodiment, a dispatcher 114 may handle emergency calls of the patients and dispatch a nearest emergency vehicle and control an emergency situation by tracking the case from the moment the emergency call is placed until a patient is delivered to the emergency room (e.g., hospital casuality, operation theatre, etc.). An emergency vehicle may be equipped with the medical equipments and medicines to treat the patient when the patient will be in transit from first location (e.g., accident place, patient's home, patient's office, etc.) to a second location (e.g., hospital, nursing home, etc.). In an example embodiment, the emergency vehicle may be an ambulance van (e.g., ambulance 104), a medivac helicopter 102, a medivac aeroplane 116, a boat 106. The dispatcher 114 may monitor all the emergency vehicles on duty and hospitals in the coverage area.

In another embodiment, the dispatcher may communicate to the emergency vehicle, and a hospital staff 110 through a network 100 (e.g., internet, intranet, satellite network, etc.). The dispatcher may also call the emergency vehicle through the telephone/mobile phone. The dispatcher 114 may trace the nearest emergency vehicle through a location tracking system 108.

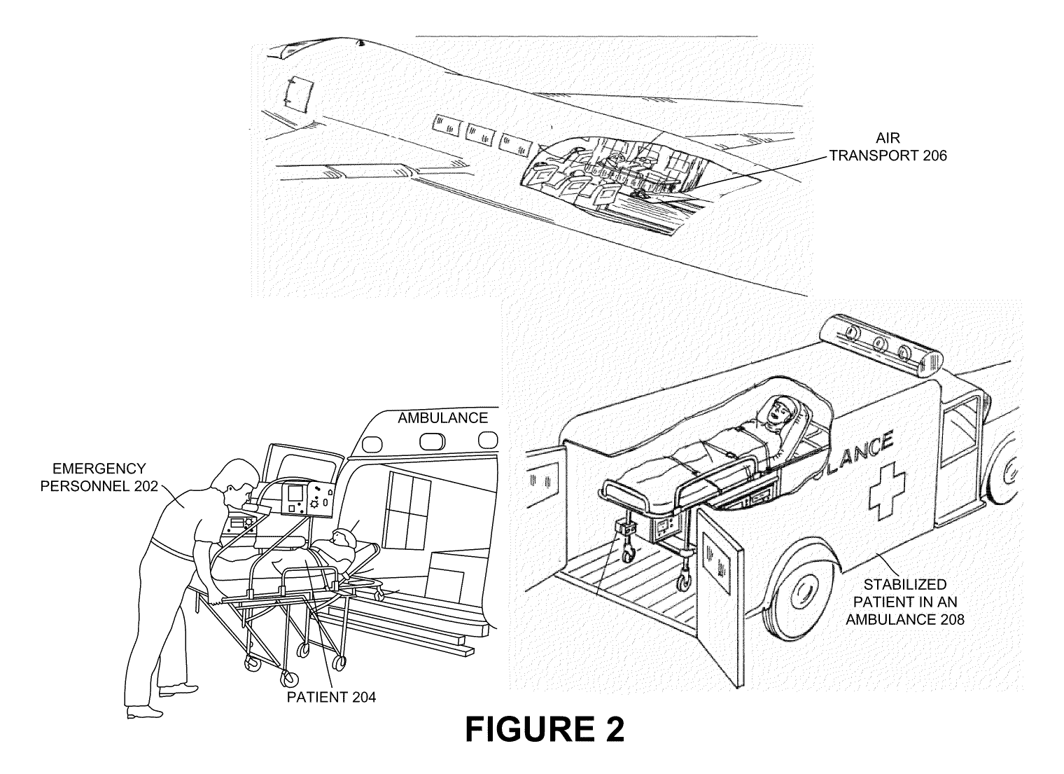

In yet another embodiment, a dispatcher may receive a call from a patient and/or a patient relative. The dispatcher may locate the nearest emergency vehicle (e.g., the ambulance 104, the boat 106, the medivac helicopter 102, the medivac aeroplane 116) using the location tracking system 108 and communicate to an emergency personnel in the emergency vehicle regarding the patient's address and location. The emergency vehicle may reach the patient's location and the emergency personnel may assess the vital conditions of the patient and move the patient into the emergency vehicle and stabilize the patient as illustrated in FIG. 2.

Each emergency vehicle may have a terminal (e.g., a laptop connected to the internet, a tablet PC (Personal computer) connected to the network, etc.) to transmit the health data to the dispatcher 114 and the hospital staff 110. The dispatcher may track the location of the vehicle (e.g., using the location tracking system) and the medical administration of the patient in the emergency vehicle when the patient will be in transit and provide the information to the nearest hospital.

The communication between dispatcher and emergency vehicle and the communication between dispatcher and hospital may be initiated through the dispatching system (e.g., computer 112B). The voice command (e.g., communication between the dispatcher 114, emergency personnel and the hospital staff 110) may be recorded and later transcribed to a text format and stored as a medical record of the patient. The health status of the patient in the emergency vehicle may be periodically updated and sent to the dispatcher 114 and the hospital staff 100 when the patient will be in transit from the patient's location to the hospital. Also, the health data of the patient may be recorded from the patient's medical identification card and the current health data may be matched with the medical data accessed from the identification card while the patient will be in transit from the patient's place to the hospital.

In addition, the emergency personnel may receive the instructions from the medical personnel (e.g., doctor) to treat the patient. The health status and the course of medical administration may be periodically updated to the hospital staff. Based on this real time information of the patient's health status, the doctors at the hospital may prepare for the further treatment of the patient to handle the emergency.

FIG. 2 is a schematic view illustrating transit of a patient in an emergency vehicle, according to one embodiment.

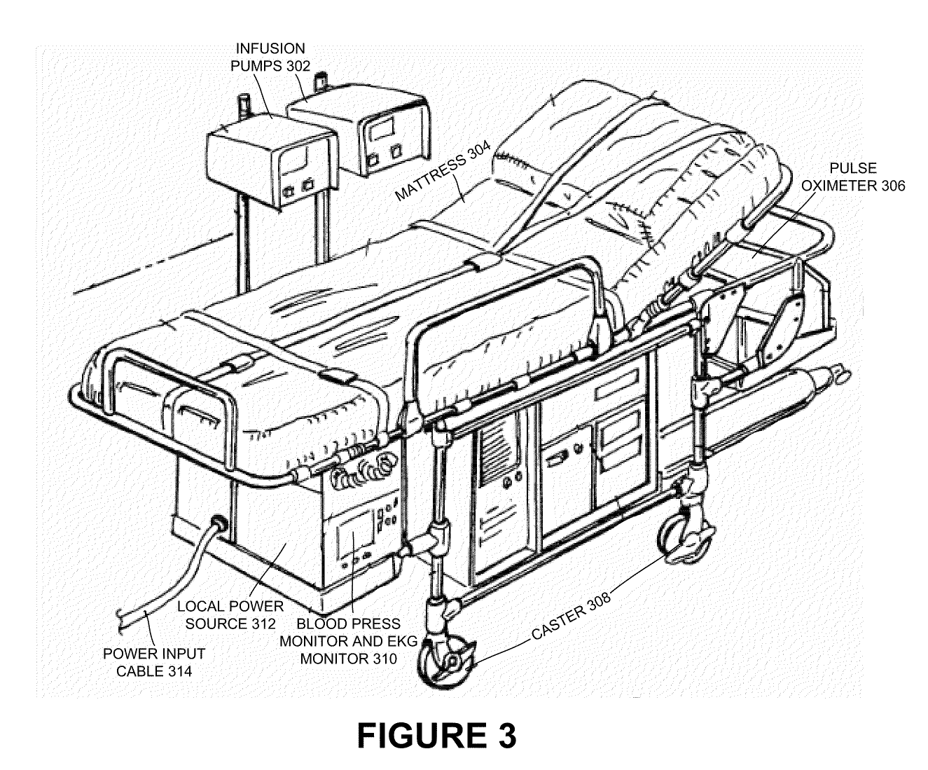

In one embodiment, an emergency personnel 202 may move a patient 204 into an emergency vehicle from the place of emergency into the emergency vehicle. The emergency personnel may be a trained Emergency Medical Technician (EMT) who may act as a first responder to treat the patient 204 at the time of emergency. After moving the patient into the emergency vehicle the emergency personnel 202 may lay down the patient 204 on a patient intensive care system (as illustrated in FIG. 3) and stabilize the patient 204 (e.g., stabilized patient in a ambulance 208 of FIG. 2). Also, the patient 204 may be transmitted in a medivac helicopter or a medivac aeroplane as illustrated in air transport 206 of FIG. 2.

FIG. 3 illustrates a diagrammatic view illustrating a patient intensive care system in an emergency vehicle, according to one embodiment.

In one embodiment, a patient intensive care system in an emergency vehicle may include a mattress 304 on which a patient (e.g., the patient 204) may be laid down. The patient monitoring system may include a caster 308 to move the system easily and a local power source 312 to supply power to the medical instruments coupled to the intensive care system. The local power source 312 may receive power from emergency vehicle and/or from a hospital power source through a power input cable 314. The patient intensive system is used to treat the patient while transporting the patient from first location to the second condition.

The patient monitoring system may be coupled to a blood pressure monitor and EKG monitor 310, a pulse oximeter 306, infusion pumps 302, etc. The pulse oximeter 306 may be used to measure the oxygen saturation in the blood and the changes in blood volume in the skin. The blood pressure monitor and EKG monitor 310 may be used to measure the blood pressure of the patient and monitor the heart rate in real time. The infusion pumps 302 may be used to infuse fluids, and medication into patient's circulatory system.

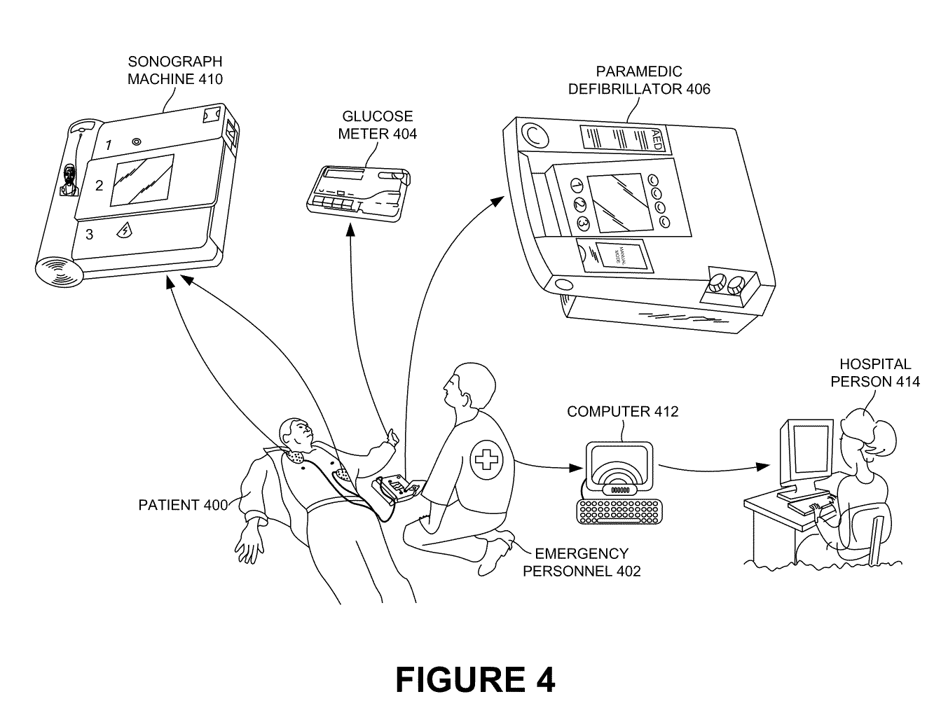

FIG. 4 is a diagrammatic view illustrating an emergency personnel transferring a patient's vital health information to a hospital person, according to one embodiment.

According to one embodiment, the emergency personnel 402 (e.g., emergency medical technician) may assess the vital conditions (e.g., blood pressure, heart rate, glucose level in the blood, etc) of the patient 400 using medical diagnostic devices and medical care devices, and transfer the health data of the patient 400 to a hospital staff 414 through a computer device 412. The medical devices connected to the patient 400 may be a sonograph machine 410, a glucose meter 404, a paramedic defibrillator 406, a troponin monitor, a pulse monitor, an electrocardiogram machine, etc.

The sonograph machine 410 may be used to visualize subcutaneous body structure including tendons, muscles, joints, vessels, etc. The glucose meter 404 may be used to determine the approximate concentration of glucose in the blood and the paramedic defibrillator 406 may be used for cardiac treatment. The hospital person may receive patient's vital health conditions (e.g., pulse, blood pressure, etc.) and emergency vehicle statistics (e.g., location, etc.) and provide the received information to the doctors. Further, the doctors may prepare for the treatment of the patient 400 based on the information sent by the emergency personnel 402.

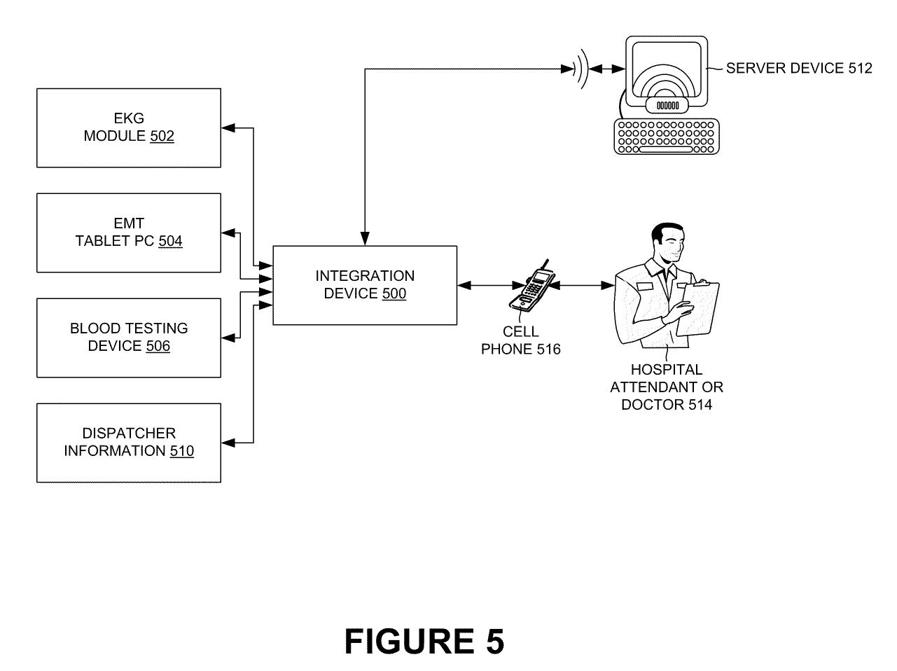

FIG. 5 is a system view illustrating communication between an integration device, a server device and a hospital attendant, according to one embodiment.

In one embodiment, an integration device 500 may communicate with a server device 512 and a hospital staff attendant or doctor 514 through a network (e.g., cellphone 516). The network may be a wireless network or a wired network which may include an internet, Satellite area network, WiFi, etc. The integration device 500 may include a processor and a memory coupled to the medical instruments capturing health data of the patient 204 when the patient 204 will be in transit from the first location to the second location.

The integration device may be connected to an EKG (Electrocardiogram) module 502, an EMT tablet PC 504, a blood testing device 506, and a dispatcher information 510. The server device 512 may be a device that may provide the requested service to a client device (e.g., computer 112A-B). The EKG module 502 may provide the data collected from the EKG monitor. The EMT tablet PC may be a personal computer that may be used by the emergency personnel 202 to transfer the patient's data and download medical protocol.

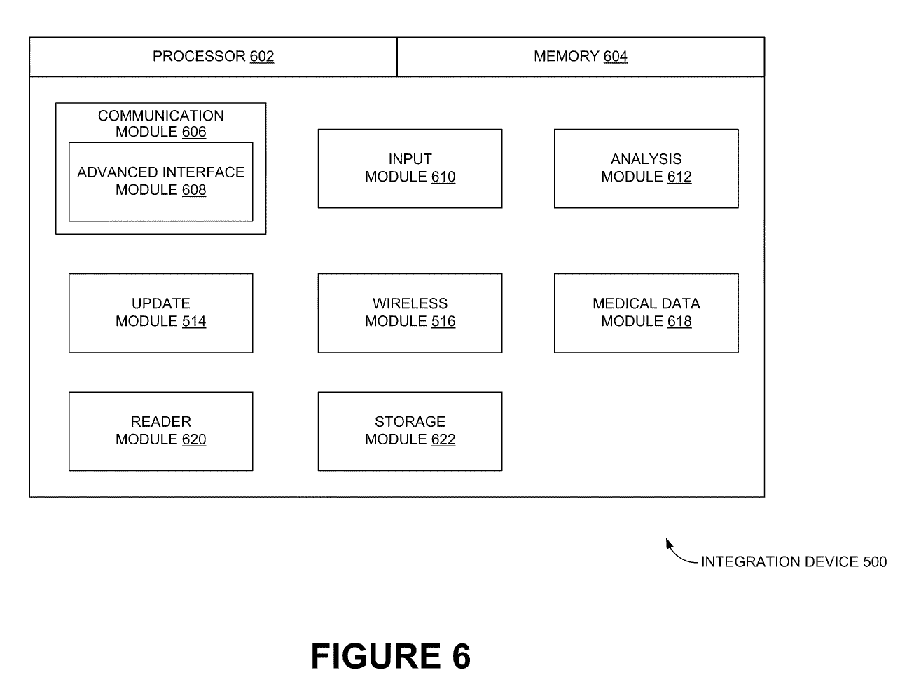

FIG. 6 is an exploded view of an integration device illustrated in FIG. 5, according to one embodiment.

In one embodiment, the integration device 500 may include a processor 602 and a memory 604. The processor 602 may assemble data from the medical equipments (e.g., the sonograph machine 410, the glucose meter 404, etc.) connected to the integration device 500 and transmit the data to a hospital, a law enforcement personnel, and/or the dispatcher 114. Furthermore, the integration device 500 may include a communication module 606, an input module 610, an analysis module 612, an update module 614, a wireless module 616, a medical data module 618, a reader module 620, and/or a storage module 622, in accordance to one embodiment.

The communication module 606 may transmit health data of a patient (e.g., the patient 204) to a dispatcher device, a hospital device, a law enforcement device and an emergency personnel device when the patient will be in transit from the first location (e.g., patient's home, accident location, etc.) to a second location (e.g., hospital). Further, the communication module 606 may include an advanced interface module 608 to transmit the medical instrument information to a doctor, the dispatcher 114, a hospital staff, etc. In an example embodiment, the advanced interface may be a Universal Serial Bus (USB) interface, a bluetooth interface, a RS-232 interface, a RS-422 interface, etc.

The input module 610, may be used to input a data by the emergency personnel 202 into the computing device (e.g., the computer 412) in the emergency vehicle. The analysis module 612 may analyze the input data and the data collected from the medical instruments. The update module 614 may update a health data of the patient 204 to the hospital based device, the dispatcher 114 and a central server (e.g., the server device 512). Also, the update module 614 may update an instruction data from the doctors and hospital staff for the treatment of the patient 204. In addition the update module 614 may update the patient health status and the location of the emergency vehicle in real time when the patient will be in transit from the patient's location to the hospital. The emergency personnel 202 may download a medical protocol to treat the patient using the wireless module 616 and the medical data of the patient may be captured by the medical data module 618.

The storage module 622 may store the health data of the patient 204, instruction data (e.g., instructions of the doctors) and communication data (e.g., communication between the emergency personnel 202 and the hospital staff, communication between the emergency personnel 202 and the dispatcher 114). The reader module 620 may read a personal data of the patient 204 which may include name, an address, a personal identification number, a license and a medical number, etc.

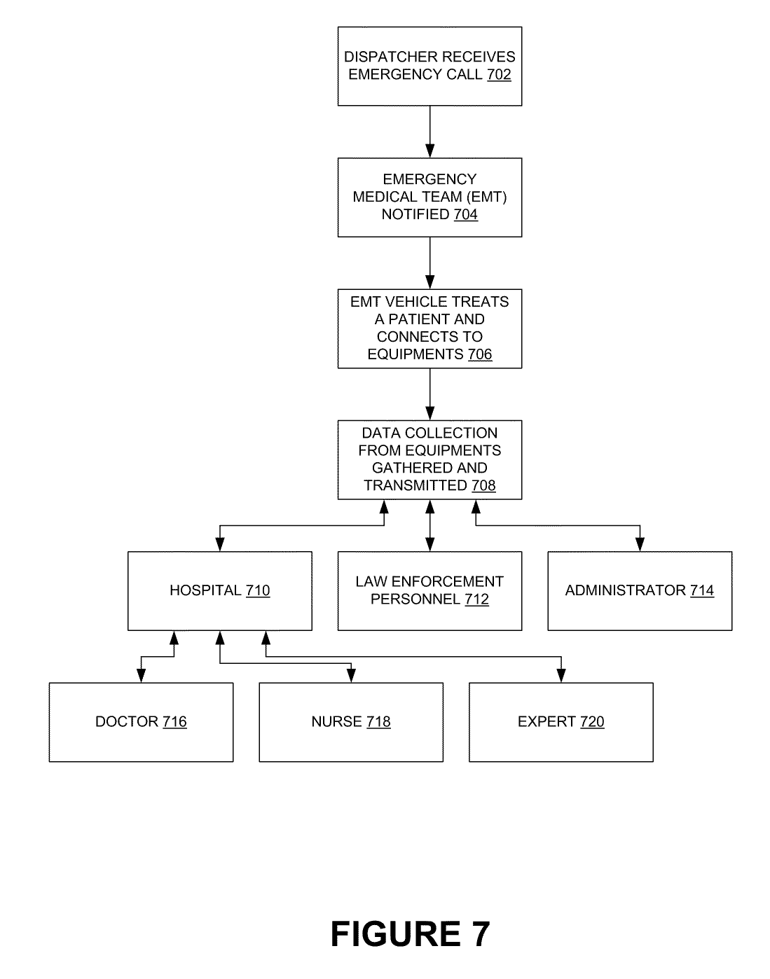

FIG. 7 is a flow chart illustrating dispatching of an emergency vehicle and transmitting a patient health information from the emergency vehicle to a hospital, a law enforcement personnel and an administrator, according to one embodiment.

In operation 702, a dispatcher (e.g., the dispatcher 114 of FIG. 1) may receive an emergency call from a patient (e.g., the patient 204). In operation 704, the dispatcher 114 may notify an emergency medical team regarding the emergency of the patient 204, and location of the patient 204. In operation 706, an emergency vehicle may reach the patient's location and the emergency personnel (the emergency personnel 202) may treat the patient 204 and connect the medical equipments (e.g., the sonograph machine 410, the paramedic defibrillator 406, the glucose meter 404, etc.) to the patient 204 and the integration device 500. In operation 708, a data from medical equipments may be gathered and transmitted to a hospital, a law enforcement personnel (e.g., Police, etc.) and/or administrator.

In operations 710, 712, and 714, the hospital, the law enforcement personnel and the administrator may receive the data collected from the medical equipments. In operations 716, 718, and 720, a doctor, a nurse and/or an expert of the hospital may assess the data received by the hospital device and prepare for the medical treatment of the patient 204.

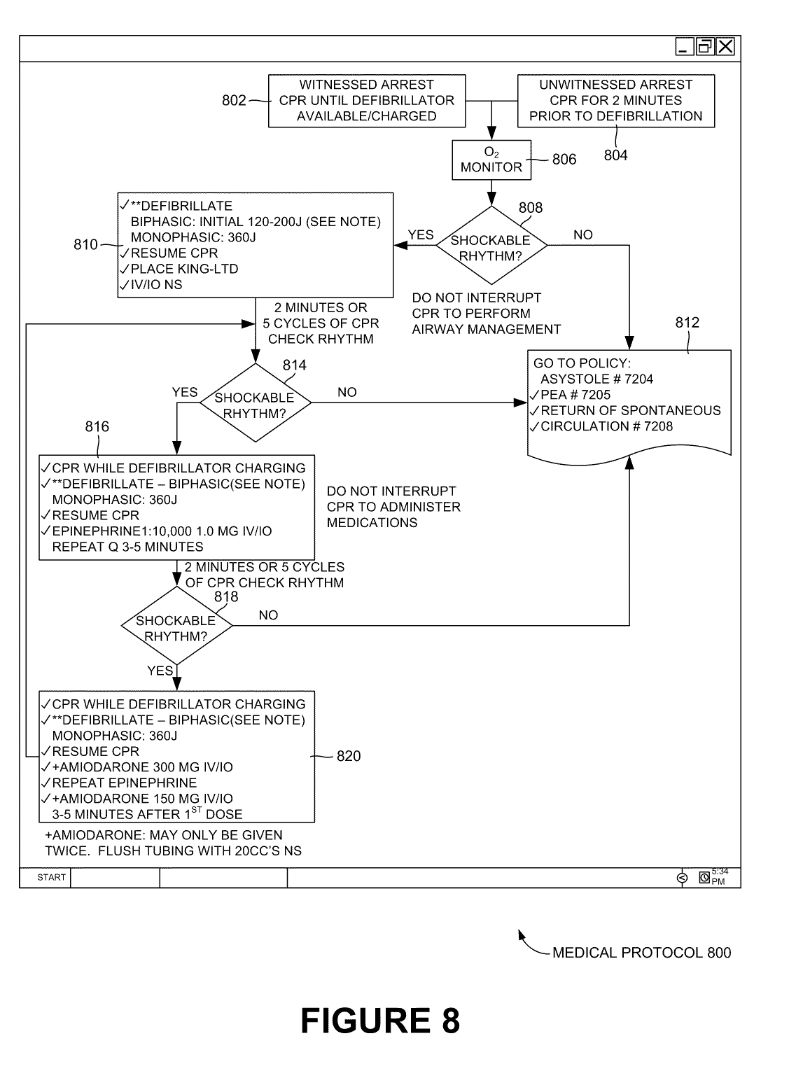

FIG. 8 is a flow chart illustrating a medical protocol for a ventricular fibrillation/ventricular tachycardia, according to one embodiment.

In one embodiment, the emergency personnel 202 may download a protocol on the EMT tablet PC 504 to treat the patient. In an example embodiment, a medical protocol for ventricular fibrillation/ventricular tachycardia is illustrated in FIG. 8. The medical protocol is treated to a patient suffering from uncoordinated contraction of the cardiac muscle.

In operation 802, when a patient suffers from a witnessed cardiac arrest CPR (cardiopulmonary resuscitation) may be given to the patient until the defibrillator is available. In operation 804, when a patient suffers from an unwitnessed cardiac arrest CPR may be given for two minutes prior to defibrillation. In operation 806, the patient may be monitored under oxygen supply. In operation 808, the patient may be monitored and checked whether the patient still suffers from a shockable rhythm. In operation 810, if the patient still suffers from the shockable rhythm in the heart, the patient may be further treated with defibrillator. The defibrillation treatment may include biphasic truncated exponential waveform of 120-200 J, monophasic 360 J. Next, the patient may be again resumed with a CPR, a king LTD may be placed and IV/IO NS therapy may be given to the patient.

In operation 812, if the patient is not suffering from the shockable rhythm in the heart, asystole treatment may be given and the patient may be treated for return of spontaneous circulation. After operation 810, five cycles or two minutes of CPR may be given to the patient. In operation 814, the patient's heart rhythm may be checked again. In operation 816, if there is a shockable rhythm the patient may be treated with CPR while charging the defibrillator. The defibrillation treatment may include biphasic and monophasic truncated exponential waveform. Then, the CPR treatment may be resumed and the patient may be further medicated with epinephrine1 10,000 1.0 mg through IV therapy (e.g., may be repeated for 3-5 minutes). During the treatment as illustrated in operation 816, CPR may not be interrupted to administer medications. Further, the patient may be treated with five cycles or two minutes of CPR to check the rhythm.

In operation 818, the patient may be checked for shockable rhythm in the heart. If there is no shockable rhythm the patient may be treated as illustrated in the operation 812. In operation 820, if the patient still suffers from the shockable rhythm the patient may be treated with CPR when defibrillator will be charging. Then, the patient may be defibrillated with biphasic and/or monophasic 360 J truncated exponential waveform. Again, CPR may be resumed and a medicine (e.g., +Amiodarone 300 mg) may be administered through IV/IO therapy. Further, the patient may be treated with epinephrine. In addition, +amiodarone 150 mg may be administered through IV therapy and may be repeated after 3-5 minutes of first dosage.

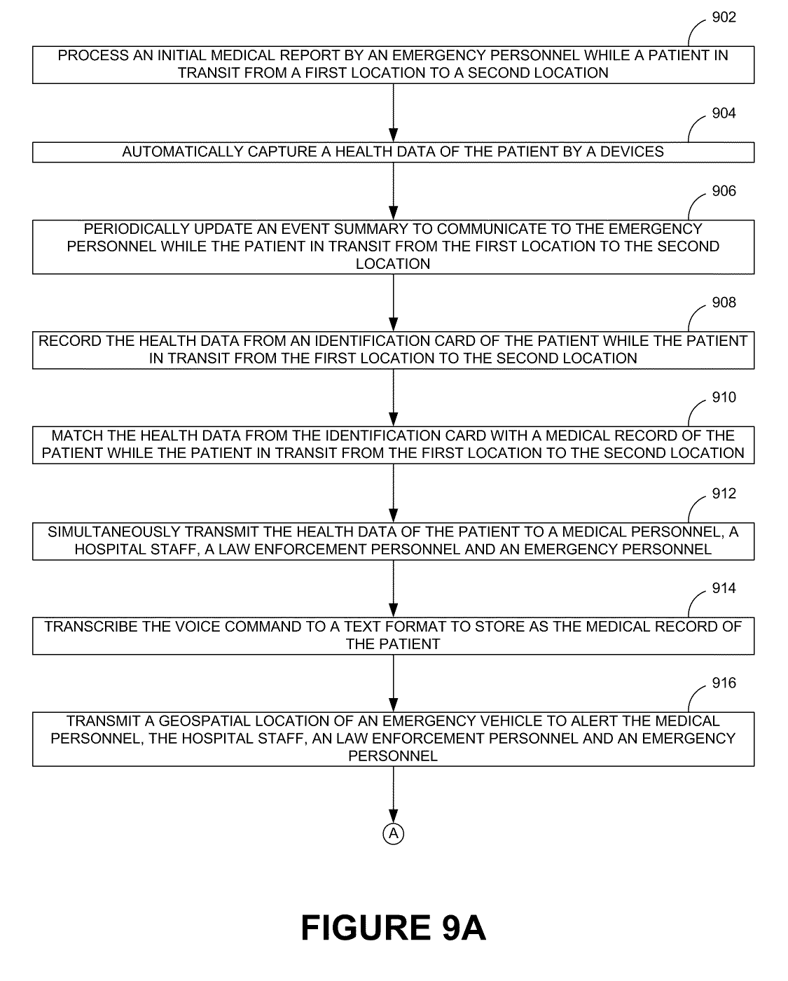

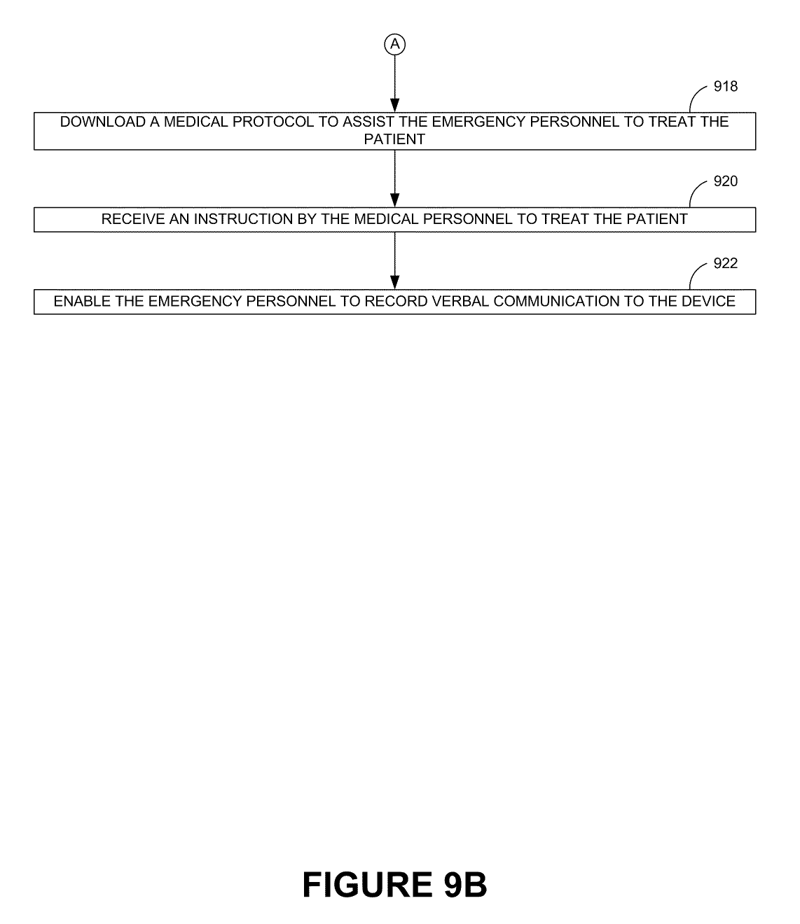

FIG. 9A is a process flow that illustrates an automated capturing of a patient health information and transmitting to a hospital based device, and/or a law enforcement personnel, according to one embodiment.

In operation 902, an initial medical report may be processed by the emergency personnel 202 (e.g., Emergency Medical Technician) while the patient 204 is in transit from a first location (e.g., patient's home, accident place, etc.) to a second location (e.g., hospital, first aid treatment center, nursing home, etc.). For example, the emergency personnel may process the initial medical report when the patient 204 will be in transit from the initial place of emergency (e.g., the first location) to the hospital (e.g., the second location).

In operation 904, a health data of the patient 204 may be automatically captured by two or more devices when the patient 204 will be in transit from the first location to the second location. For example, the devices may include a medical device, a medical diagnostic device, a medical care device, a voice command device, a recording device of the emergency personnel and/or a mobile device. In operation 906, an event summary may be periodically updated to communicate to the emergency personnel 202 when the patient 204 will be in transit from the first location to the second location.

In operation 908, the health data from an identification card of the patient may be recorded when the patient 204 will be in transit from the first location to the second location. In operation 910, the health data from the identification card may be matched with a medical record of the patient 204 when the patient 204 will be in transit from the first location to the second location. In operation 912, the health data of the patient 204 may be simultaneously transmitted to a medical personnel, a hospital staff, a law enforcement personnel and/or the emergency personnel. The medical diagnostic device may be a blood glucose monitor, a troponin monitor and/or a blood testing machine. The medical care device may be a pulse monitor, an electrocardiogram machine, an x-ray machine and/or a sonogram machine.

In operation 914, the voice command may be transcribed to a text format to store as the medical record of the patient 204. In operation 916, a geospatial location of an emergency vehicle (e.g., the medivac helicopter 102, the medivac aero plane 116, the ambulance van 104, the boat 106, etc.) may be transmitted to alert the medical personnel, the hospital staff, the law enforcement personnel and/or an emergency personnel. For example, the location tracking system 108 may track a geospatial location of an emergency vehicle and transmit the information to the hospital staff, and/or the law enforcement personnel.

FIG. 9B is a continuation of the process flow illustrated in FIG. 9A illustrating additional operations, according to one embodiment. In operation 918, a medical protocol may be downloaded to assist the emergency personnel 202 to treat the patient 204. In operation 920, an instruction may be received by the medical personnel to treat the patient 204. In operation 922, the emergency personnel 202 may be enabled to record verbal communication to the device.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A system, comprising:
an instrument to capture a health data of a patient while the patient is in transit from a first location to a second location;
an integration device having a processor and a memory coupled to the instrument and other instruments capturing the health data of the patient is in transit from the first location to the second location; and
a communication module of the integration device to transmit the health data at least to one of a client device, a dispatcher device, a hospital based device, a law enforcement device and an emergency personnel device while the patient is in transit from the first location to the second location.

2. A system of claim 1 further comprising;
an input module to process an instruction data at least from one of an emergency personnel, a doctor, a patient, a dispatcher, a hospital staff, and a law enforcement personnel;
an analysis module of the integration device to collect a group communication data from at least one of the client device, the dispatcher device, the hospital based device, the law enforcement device and the emergency personnel device; and
an update module to periodically process and store at least one of the health data, the instruction data and the group communication data with a central server.

3. A system of claim 1, wherein the instrument is at least one of a medical device, a medical diagnostic device, a medical care device, a voice command device, a recording device of the emergency personnel and a mobile device.

4. A system of claim 1 further comprising a wireless module to download a medical protocol by the emergency personnel.

5. A system of claim 1 further comprising a medical data module of the integration device to capture a medical data of the patient.

6. A system of claim 1 further comprising a reader module to electronically read a personal data by at least from one of the emergency personnel, the doctor, the patient, the dispatcher, the hospital staff, and the law enforcement personnel.

7. A system of claim 6 further comprising a storage module to capture at least one of the health data, the instruction data, a communication data, the medical protocol, the medical data and the personal data.

8. A system of claim 7, wherein the personal data is at least one of a name, an address, a personal identification number, a license and a medical number.

9. A system of claim 1 further comprising an advanced interface module of the communication module to transmit the instrument information to at least one of the emergency personnel, the doctor, the patient, the dispatcher, the hospital staff, and the law enforcement personnel.

10. A system of claim 9 wherein the advanced interface module is at least one of a universal serial bus (USB) interface, a Bluetooth interface, a Zigbee interface, a WiFi interface, a WiMax, a PoE, a Wibree, a RS-232, a RS-422, a RS-485, and an Ethernet interface.

11. A method, comprising:
processing an initial medical report by an emergency personnel while a patient in transit from a first location to a second location;
automatically capturing a health data of the patient by a plurality of devices, wherein the plurality of devices are at least one of a medical device, a medical diagnostic device, a medical care device, a voice command device, a recording device of the emergency personnel and a mobile device while the patient in transit from the first location to the second location;
periodically updating an event summary to communicate to the medical personnel while the patient in transit from the first location to the second location;
recording the health data from an identification card of the patient while the patient in transit from the first location to the second location; and
matching the health data from the identification card with a medical record of the patient while the patient in transit from the first location to the second location.

12. A method of claim 11 further comprising simultaneously transmitting the health data of the patient to at least one of a medical personnel, a hospital staff, a law enforcement personnel and the emergency personnel.

13. A method of claim 11, wherein the medical diagnostic device is at least one of a blood glucose monitor, a troponin monitor and a blood testing machine.

14. A method of claim 11, wherein the medical care device is at least one of a pulse monitor, an electrocardiogram machine, an x-ray machine and a sonogram machine.

15. A method of claim 11 further comprising transcribing the voice command to a text format to store as the medical record of the patient.

16. A method of claim 11 further comprising transmitting a geospatial location of an emergency vehicle to alert at least one of the medical personnel, the hospital staff, the law enforcement personnel and the emergency personnel.

17. A method of claim 11 further comprising downloading a medical protocol to assist the emergency personnel to treat the patient.

18. A method of claim 11 further comprising receiving an instruction by the medical personnel to treat the patient.

19. A method of claim 11 further comprising backing up the device data to a secure database.

20. A method of claim 11 further comprising enabling the emergency personnel to record verbal communication to the device.

21. A method comprising:
automatically capturing a health data of a patient by a plurality of devices, wherein the plurality of devices are at least one of a medical device, a medical diagnostic device, a medical care device, a voice command device, a recording device of an emergency personnel and a mobile device while the patient in transit from a first location to a second location;
recording the health data from an identification card of the patient while the patient in transit from the first location to the second location; and
matching the health data from the identification card with a medical record of the patient while the patient in transit from the first location to the second location.

22. The method of claim 21 further comprising:
periodically updating an event summary to communicate to the emergency personnel while the patient is in transit from the first location to the second location;
processing an initial medical report by the emergency personnel while the patient is in transit from the first location to the second location; and
simultaneously transmitting the health data of the patient to at least one of a medical personnel, a hospital staff, a law enforcement personnel and the emergency personnel.

23. A method of claim 21, wherein the medical diagnostic device is at least one of a blood glucose monitor, a troponin monitor and a blood testing machine.

24. A method of claim 21, wherein the medical care device is at least one of a pulse monitor, an electrocardiogram machine, an x-ray machine and a sonogram machine.
